(19) United States
(12) Patent Application Publication
(10) Pub. No.: US 2026/0226286 A1
(43) Pub. Date: Aug. 6, 2026

(54) COATED ARTICLES THAT DEMONSTRATE REDUCED FOULING AND METHODS OF REDUCING ADHESION OF SUBSTANCES TO A SUBSTRATE

(71) Applicant: ACULON, INC., SAN DIEGO, CA (US)

(72) Inventors: Eric L. Hanson, Carlsbad, CA (US); Paul Lord, Houston, TX (US)

(21) Appl. No.: 19/436,693

(22) Filed: Dec. 30, 2025

Related U.S. Application Data
(60) Provisional application No. 63/740,166, filed on Dec. 30, 2024.

(51) Int. Cl. C09D 5/16; B01D 17/04; C08K 5/00; C09D 7/63; C09D 133/14

(52) U.S. Cl. CPC C09D 5/1668; B01D 17/045; C09D 5/1625; C09D 7/63; C09D 133/14; C08K 5/0091

(57) ABSTRACT

The present disclosure provides coated articles such as components of an oil-water emulsion separator, comprising: (1) a substrate; and (2) a coating layer applied to at least one surface of the substrate. The coating layer comprises (a) a hydrophilic polymer that is ionic or zwitterionic; and (b) optionally an organometallic compound. The substrate is a component of industrial equipment, commercial equipment or residential appliances. The disclosure further provides methods of reducing adhesion of an inorganic or organic substance to a substrate, comprising applying to at least one surface of the substrate a coating layer comprising: (a) a hydrophilic polymer that is ionic or zwitterionic; and (b) optionally an organometallic compound.

### RELATED APPLICATIONS

The present application claims the benefit of U.S. Provisional Patent Application Ser. No. 63/740,166, filed Dec. 30, 2024, and titled “Coated Articles that Demonstrate Reduced Fouling and Methods of Reducing Adhesion of Substances to a Substrate”, which application is incorporated herein by reference in its entirety.

### FIELD OF THE INVENTION

The present invention relates to coated articles that are components of industrial equipment, commercial equipment or residential appliances, the components having thin coatings that demonstrate hydrophilicity and fouling resistance. The present invention is further related to methods of reducing adhesion of an inorganic substance to a substrate and reducing adhesion of an organic substance to a substrate.

### BACKGROUND OF THE INVENTION

Changing the surface energy of a substrate is of great value in many diverse industries and products, including oil, gas and energy production and other operations in the oil and gas industry, as well as on components of industrial equipment and commercial or residential appliances and the like. Depending on the needs and applications, substrate surfaces can be customized to exhibit hydrophilic, hydrophobic, oleophobic and oleophilic properties in order to exhibit selective wetting. For example, exceptionally hydrophilic surfaces are particularly desired in certain environments to prevent fouling of equipment by inorganic scale (e.g. calcium carbonate, barium sulfate, magnesium carbonate), tar, resins, aromatic hydrocarbons, alkanes, bitumens, paraffinic compounds and/or asphaltene-type compounds.

Scientifically, liquids with lower surface tensions (e. g., oil with surface tensions <30 mN/m) tend to wet solid surfaces (with specific surface energy) more than liquids with higher surface tensions (e. g., water with surface tension of 72.8 mN/m). Coated surfaces may be prepared to yield different contact angles for liquids with higher surface tensions compared to those with lower surface tensions.

A current solution to this problem of fouling of surfaces is through the use of fluorinated coatings that can resist significant adsorption of the organic fouling compounds. While these treatments are certainly effective for organic compounds, they have been found to increase the adsorption of inorganic scale. Furthermore, they contain perfluorinated compounds that are suspected to be hazardous and are highly persistent in the environment.

Even more critical is that the hydrophilic coatings (e. g., polyethylene glycol-based coatings) that have been developed as anti-scale coatings cannot repel hydrocarbon-based contaminants, so there is currently no effective strategy to repel both organic and inorganic fouling compounds with surface treatments.

It would be desirable to provide coated articles that demonstrate hydrophilicity and fouling resistance, methods of reducing adhesion of an organic substance to a substrate, and methods of reducing adhesion of an inorganic substance to a substrate, while overcoming the drawbacks of the prior art.

### SUMMARY OF THE INVENTION

The present invention provides coated articles comprising:
(1) a substrate; and
(2) a coating layer applied to at least one surface of the substrate. The coating layer comprises (a) a hydrophilic polymer that is ionic or zwitterionic; and (b) optionally an organometallic compound. The substrate is a component of industrial equipment, commercial equipment or residential appliances, such as a component of an oil-water emulsion separator.

The invention further provides methods of reducing adhesion of an inorganic or organic substance to a substrate, comprising applying to at least one surface of the substrate a coating layer comprising:
(a) a hydrophilic polymer that is ionic or zwitterionic; and
(b) optionally an organometallic compound.

### BRIEF DESCRIPTION OF THE DRAWINGS

FIGS. 1A and B are schematic isometric side and end views, respectively, of a coated article (storage tank) 10 of the present invention, such as are used in any of various industries listed below.

FIG. 2 is a schematic view of a particular example of a coated article 10 in accordance with the present invention. The article comprises a substrate 22 and a coating layer 24 applied to one surface thereof.

FIG. 3 is a schematic view of a particular example of a coated article 10 in accordance with the present invention. The article comprises a substrate 22 and a coating layer 24 applied to both opposing surfaces thereof.

FIG. 4 is a schematic sectional view of a coated article (component of a cross flow oil-water emulsion separator) 10 according to an embodiment of the present invention.

FIG. 5 is a schematic sectional view of a coated article (component of an end flow oil-water emulsion separator) 10 according to an embodiment of the present invention.

FIG. 6 is a schematic sectional view of a coated article (component of an end flow oil-water emulsion separator) 10 according to an embodiment of the present invention. The component comprises a substrate 22 and a coating layer 24 applied to both opposing surfaces thereof.

FIG. 7 is a schematic view of a coated article (component of a heat exchanger) 10 according to an embodiment of the present invention, such as are used in any of various industries listed below.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various aspects and examples of the present invention as presented herein are each understood to be non-limiting with respect to the scope of the invention.

As used in the following description and claims, the following terms have the meanings indicated below:

The terms “on”, “appended to”, “affixed to”, “bonded to”, “adhered to”, or terms of like import means that the designated item, e.g., a coating, film or layer, is either directly connected to (in contact with) the object surface, or indirectly connected to the object surface, e.g., through one or more other coatings, films or layers.

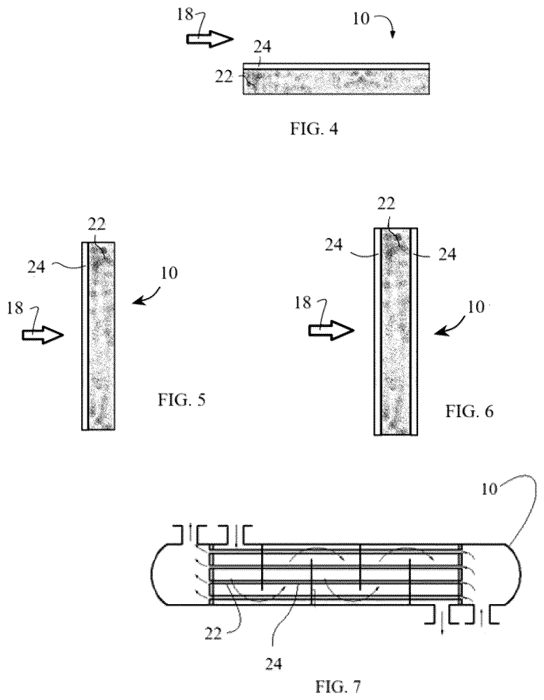

The coated articles 10 of the present invention comprise (a) a substrate 22. The substrate is a component of at least one of: an oil-water emulsion separator (see FIGS. 4-6), a steam generator, an oil preheater, a pump, a valve, a pipe, a meter, a water heater, a water injection line, a distillation column, completion equipment, a storage tank, a clarifier, a settling tank, an HVAC system, a cooling tower, a pasteurizer, a refrigeration system, a chiller, a condenser, an evaporative cooler, a boiler, a condensate recovery system, a steam trap, a deaerator, an economizer, a water treatment system, a membrane, a seawater intake pipe, a ballast tank, a scrubber, a ship hull, a plumbing system, a plumbing fixture, an appliance, a humidifier, a dehumidifier, a brine treatment system, and food processing equipment. For example, the substrate 10 may be a component of any of the following:

### 1) Oil and Gas Industry:

### Production Equipment:

Separators (see FIGS. 4-6)
Heaters
Pumps
Valves

### Flow Lines and Pipelines

Crude Oil Pipelines
Water Injection Lines

### Refinery Equipment

Heat Exchangers
Distillation Columns

### Downhole Equipment

Casing and Tubing
Completion Equipment

### Storage Tanks

Produced Water Tanks

### 2) Heat Exchangers Industry (see FIG. 7)

### Industrial Heat Exchangers

Shell-and-Tube Heat Exchangers
Plate Heat Exchangers

### HVAC Systems

Chilled Water Systems
Condensing Units

### Power Generation

Steam Generators
Cooling Towers

### Process Industries

Chemical Processing
Petrochemical Refineries

### Food and Beverage Industry

Pasteurizers
Refrigeration Systems

### Marine and Offshore Applications

Heat Exchangers on Vessels
Offshore Platforms

### 3) Cooling Systems Industry:

### Cooling Towers

Open-Circuit Cooling Towers
Closed-Circuit Cooling Towers

### Chillers

Air-Cooled Chillers
Water-Cooled Chillers

### Heat Exchangers in HVAC Systems (see FIG. 7)

Plate Heat Exchangers
Shell-and-Tube Heat Exchangers

### Condenser Units

Air-Cooled Condensers
Water-Cooled Condensers

### Evaporative Coolers

### Refrigeration Systems:

Industrial Refrigeration
Commercial Refrigeration Units

### District Cooling Systems

### Geothermal Cooling Systems

### 4) Boiler Systems

### Steam Boilers

Industrial Boilers
Commercial Boilers

### Condensate Systems

Condensate Recovery Systems
Steam Traps

### Feedwater Systems

Deaerators
Economizers

### Hot Water Boilers

Low-Pressure Hot Water Boilers
High-Pressure Hot Water Boilers

### Heat Recovery Steam Generators (HRSGs)

### Water-Tube Boilers

### Fire-Tube Boilers

### Auxiliary Boilers on Ships and Offshore Platforms

### 5) Water Treatment:

### Water Filtration Systems

Membrane Filtration (Reverse Osmosis, Nanofiltration, Ultrafiltration)

### Desalination Plants

Reverse Osmosis (RO) Units
Thermal Desalination (Multi-Stage Flash and Multi-Effect Distillation)

### Municipal Water Treatment

Clarifiers and Settling Tanks
Distribution Pipelines
Water Storage Tanks (see FIG. 1)

### Industrial Wastewater Treatment

Cooling Tower Blowdown Treatment Systems
Zero Liquid Discharge (ZLD) Systems
Oil/Water Separators (OWS) (see FIGS. 4-6)

### Boiler and Cooling Systems

### 6) Marine Applications:

### Seawater Cooling Systems

Heat Exchangers (Shell-and-Tube, Plate Type) (see FIG. 7)
Seawater Intake Pipes
Cooling Water Condensers

### Ballast Water Management Systems

Ballast Tanks (see FIG. 1)
Pumps and Valves

### Desalination Systems on Ships and Offshore Platforms

Reverse Osmosis (RO) Units
Thermal Desalination (MED and MSF Systems)

### Oily Water Separators (OWS)

Separator Chambers
Coalescing Plates and Baffles

### Marine Engines and Power Systems

Heat Exchangers and Cooling Jackets
Exhaust Gas Scrubbers

### Freshwater and Potable Water Systems on Ships

Storage Tanks (see FIG. 1) and Pipes
Water Filtration Units

### Hull Components and Marine Structures

Seawater Intake Grates and Strainers
Hull Penetrations and Overboard Discharge Lines

### 7) Residential Applications:

### Plumbing and Water Distribution Systems

Pipes (Hot and Cold-Water Lines)
Valves, Faucets, and Fittings
Water Meters

### Water Heaters and Boilers

Tank Water Heaters
Tankless Water Heaters
Residential Boilers

### Home Appliances

Dishwashers
Washing Machines
Coffee Makers, Kettles, and Steam Irons

### Water Treatment Systems

Water Softeners and Filters
Point-of-Use Water Filters (Under-Sink, Refrigerator)
Reverse Osmosis (RO) Systems

### Bathrooms and Showers

Showerheads and Taps
Glass Shower Doors and Enclosures
Bathtubs and Sinks

### HVAC Systems

Humidifiers and Dehumidifiers
Radiant Heating Systems
Air Conditioners (Evaporative Coolers)

### 8) Industrial Equipment:

### Heat Exchangers and Cooling Systems (see FIG. 7)

Shell-and-Tube Heat Exchangers
Plate Heat Exchangers
Chillers and Cooling Towers

### Boilers and Steam Generators

Water-Side Boiler Tubes
Steam Condensers
Autoclaves and Steam Sterilizers

### Pumps, Valves, and Piping Systems

Centrifugal and Positive Displacement Pumps
Valves (Ball, Gate, Check, and Control Valves)
Industrial Piping (Process and Utility Lines)

### Filtration and Separation Equipment

Filters and Strainers
Centrifuges and Clarifiers
Membrane Systems (UF, NF, and RO)

### Chemical Process Equipment

Reactors and Mixers
Storage Tanks and Agitators
Chemical Dosing Systems

### Industrial Water Treatment Systems

Cooling Water Treatment Systems
Boiler Water Treatment Systems
Effluent Treatment Systems

### 9) Geothermal Systems:

### Geothermal Heat Exchangers (see FIG. 7)

Plate Heat Exchangers
Shell-and-Tube Heat Exchangers
Direct-Contact Heat Exchangers

### Geothermal Wells and Pipelines

Production Wells (Hot Fluid Extraction)
Reinjection Wells
Geothermal Pipelines

### Geothermal Power Plants

Steam Turbines
Condensers
Cooling Towers and Fans

### Geothermal HVAC Systems

Ground Source Heat Pumps (GSHPs)
Hydronic Heating Systems
District Heating Systems

### Brine Treatment Systems

Brine Pre-Treatment Units
Crystallizers and Evaporators
Injection Pumps and Valves

### 10) Food and Beverage Processing:

### Heat Transfer Equipment (see FIG. 7)

Plate Heat Exchangers
Shell-and-Tube Heat Exchanger
Evaporators and Concentrators

### Steam and Hot Water Systems

Boilers and Steam Generators
Steam Pipes and Condensate Lines
Autoclaves and Sterilizers
Pumps, Valves, and Piping
Centrifugal and Positive Displacement
Valves (Butterfly, Ball, Gate, and Control Valves)
Process Piping and Tubing Systems

### Filtration and Separation Equipment

Microfiltration (MF), Ultrafiltration (UF), and Reverse Osmosis (RO) Systems
Centrifuges and Clarifiers
Filters and Strainers

### Storage and Mixing Equipment

Stainless Steel Storage Tanks (see FIG. 1)
Mixers and Agitators
Silos and Holding Vessels

### Packaging and Filling Systems

Filling Machines and Nozzles
Conveyors and Bottle Rinsers
Capping and Labeling Machines

As noted above, FIGS. 1A and B are schematic isometric side and end views, respectively, of a coated article (storage tank) 10 of the present invention. Typically, the coating layer is applied to the interior of the tank 10.

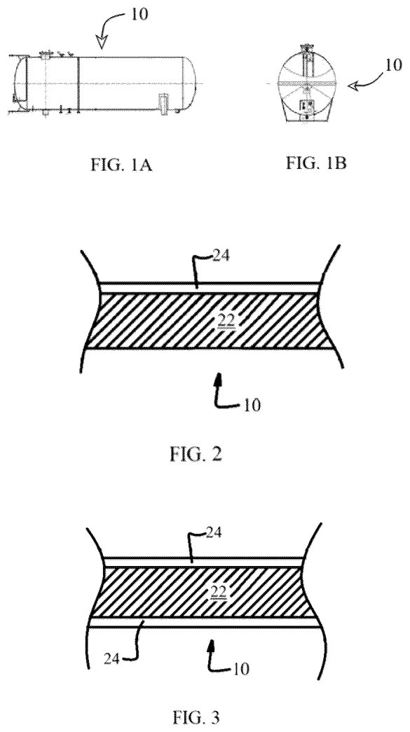

FIG. 2 is a schematic view of a particular example of a coated article 10 comprising a substrate 22 and a coating layer 24 applied to one surface thereof. In FIG. 3, a coated article 10 comprising a substrate 22 and a coating layer 24 applied to both opposing surfaces thereof is illustrated. As shown in FIG. 2, substrates 22 suitable for use in the preparation of the components (coated articles) 10 of the present invention can include at least one of metal oxide, cast iron, steel alloy (such as carbon steel and stainless steel), copper, copper alloy (e. g., brass, bronze), aluminum, PVC, CPVC, rubber, fluoropolymer (PTFE), polyether ether ketone (PEEK), fiber-reinforced plastic (FRP), ABS plastic, PEX plastic, concrete, cement, fused quartz glass, soda lime silica glass, sodium borosilicate glass, lead oxide glass, aluminosilicate glass, ceramic, polyolefin (for example, HDPE, LDPE, and polypropylene), nickel, nickel alloy, titanium, titanium alloy, chromium, chromium alloy, nickel-chromium alloy, and silicone.

FIGS. 4 to 6 are schematic sectional views of coated articles (components of an oil-water emulsion separator) 10. An end-flow configuration, wherein a stream 18 to be separated is passed through the separator component 10 (usually a membrane) is shown in FIGS. 5 and 6. Alternatively, the stream 18 may flow parallel to the separator component 10 in a cross-flow configuration, as shown in FIG. 4.

The substrates 22 may be porous or nonporous. Porous substrates may be inherently porous or may be perforated with ordered or random microarrays of microchannels. “Microchannels” are understood to be micro-dimensional fluidic channels (e. g., having average diameters on a micron or nanometer scale). In microtechnology, a microchannel is understood to have a hydraulic diameter below 1 millimeter.

The substrate 22 may take any shape as desired for the intended application, such as flat, including planar or corrugated, curved, bowl-shaped, tubular, or flexible freeform, depending on the final product. For example, the substrate 22 may be in the form of a flat (i. e., planar) plate or sheet having two opposing surfaces (see FIGS. 2 to 6). The thickness of the substrate 22 likewise depends on the nature of the final product. The coating layer 24 may be formed on at least one, up to all of the surfaces of the substrate 22, such as one of two opposing surfaces (as shown in FIGS. 2, 4 and 5); both of two opposing surfaces (as shown in FIGS. 3 and 6) or the interior surfaces of a component such as a pipe or tank 10 (see FIG. 1).

Before applying the coating layer 24 to the substrate 22, the surface of the substrate 22 may be modified by any of a variety of well-known techniques such as corona or argon plasma discharge, or chemical etching (particularly using a NaOH or KOH solution), to generate reactive functional groups, such as hydroxyl, amine, carboxyl, and/or epoxy functional groups, on the substrate surface.

The coated articles 10 further comprise (2) a coating layer 24 applied to at least one surface of the substrate 22.

The coating layer 24 comprises (a) a hydrophilic polymer that is ionic or zwitterionic. By “hydrophilic” is meant attracted to water; on hydrophilic materials, the contact angle of water is less than 90°, often less than 75°, or less than 50°. A zwitterionic molecule has an equal number of positively and negatively charged functional groups, yielding a molecule with a net neutral (zero) charge. For the purposes of this disclosure, an ionic molecule exhibits a net positive or negative charge, and may contain only positively charged functional groups, only negatively charged functional groups, or unequal numbers of both. Often the hydrophilic polymer (a) is zwitterionic functional and comprises a reaction product of a reaction mixture comprising at least one ethylenically unsaturated zwitterionic monomer.

Monomers that may be used to prepare an ionic polymer include, for example, 3-(meth)acrylamidopropyl trialkylammonium chloride, 2-(meth)acrylamido-2-methyl-1-propanesulfonic acid, 2-(meth)acrylamido-2-methyl-1-propylsodium sulfonate, and 2-(meth)acrylamido-2,2-dimethylethylsodium sulfonate. As used herein and in the claims, the term “(meth)acrylate” and similar terms refer to acrylates, methacrylates and mixtures of acrylates and methacrylates; similarly for (meth)acrylamide.

Exemplary ethylenically unsaturated zwitterionic monomers include betaine-containing monomers such as carbobetaines and sulfobetaines. These monomers typically have the following structure:

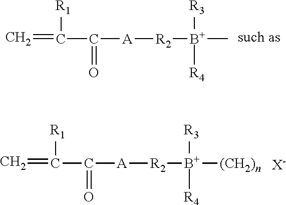

where R₁ is hydrogen or methyl; A is oxygen or —NH—; R₂ is ethylene or n-propylene; R₃ and R₄ are alkyl typically containing from 1 to 4 carbon atoms, such as a methyl group; B is N or P; n is an integer of 1 to 4; and X⁻ is SO₃⁻ or CO₂⁻. Examples of such monomers are [2-(methacryloyloxy)ethyl]dimethyl-(3 sulfopropyl)ammonium hydroxide and [2-(methacryloyloxy)ethyl]dimethyl-(2 carboxyethyl)ammonium hydroxide. In a particular example, R₁ is hydrogen or methyl; A is —NH—; R₂ is n-propylene; R₃ and R₄ are methyl; B is N; n is 4; and X⁻ is SO₃⁻.

Typically the reaction mixture used to prepare the hydrophilic polymer (a) comprises one or more zwitterionic monomers such as those described above, and may further comprise at least one different ethylenically unsaturated monomer comprising ethylene, propylene, vinyl aromatic compounds such as styrene and vinyl toluene, (meth)acrylic acid and esters thereof such as methyl (meth)acrylate and ethyl (meth)acrylate; substituted esters thereof such as hydroxypropyl(meth)acrylate and hydroxyethyl(meth)acrylate; (meth)acrylamide, 3-(meth)acrylamidopropyl trialkylammonium chloride, N,N′-methylene di(meth)acrylamide (which allows for crosslinking of the polymer if desired), 2-(meth)acrylamido-2-methyl-1-propanesulfonic acid, 2-(meth)acrylamido-2-methyl-1-propylsodium sulfonate, 2-(meth)acrylamido-2,2-dimethylethylsodium sulfonate and/or an ester of (meth)acrylic acid.

The coating layer 24 also optionally comprises (b) an organometallic compound. The organometallic compound may comprise tantalum, titanium, zirconium, lanthanum, hafnium, niobium, aluminum, and/or tungsten. Metal alkoxides are often used; an exemplary organometallic compound is tantalum (V) ethoxide. The organometallic compound (b) aids in binding the coating layer 24 to the substrate 22. The organometallic compound may not be necessary when the hydrophilic polymer (a) is an ionic polymer.

The hydrophilic polymer (a) may be prepared prior to application of the coating layer 24 to the substrate 22, and a film-forming composition comprising the polymer and optionally the organometallic compound is applied to the substrate 22 to form the coating layer 24. More often, the hydrophilic polymer (a) is formed on the surface of the substrate 22 by reaction of monomers in a reaction mixture on the surface of the substrate. In this scenario, an initiator may be applied to the intended substrate 22 prior to initiation of the polymerization process. The substrate 22 coated with initiator is then contacted with the reaction mixture and polymerization is conducted under controlled radical polymerization conditions, such as by ATRP, to form a thin coating of an ionic or zwitterionic functional polymer on the surface of the substrate 22. Living polymerization such as controlled radical polymerization of the monomers results in covalent bonding of the zwitterionic or ionic functional polymer to the substrate surface, ensuring good adhesion and minimal thickness.

When ATRP is used as the polymerization method to form the hydrophilic polymer (a), the reaction mixture may further comprise an ATRP polymerization catalyst, typically a transition metal compound, which participates in a reversible redox cycle with the initiator; and a ligand, which coordinates with the transition metal compound. The ATRP process is described in further detail in International Patent Publication No. WO 98/40415 and U.S. Pat. Nos. 5,807,937, 5,763,548 and 5,789,487, which are incorporated herein by reference. The resulting polymer has a low polydispersity index because chain transfer reactions are minimized. Lower polydispersity indices enable the molecular weight of the polymer to be controlled and optimized for the particular application intended.

Catalysts that may be used in the ATRP process include any transition metal compound. It is preferred that the transition metal compound not form direct carbon-metal bonds with the polymer chain. Transition metal catalysts useful in the present invention may be represented by the following general formula:

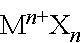

wherein M is the transition metal, n is the formal charge on the transition metal having a value of from 0 to 7, and X is a counterion or covalently bonded component. Examples of the transition metal M include, but are not limited to, Cu, Fe, Au, Ag, Hg, Pd, Pt, Co, Mn, Ru, Mo, Nb and Zn. Examples of X include, but are not limited to, halide, hydroxy, oxygen, C₁-C₆ alkoxy, cyano, cyanato, thiocyanato and azido. A preferred transition metal is Cu(I) and X is preferably halide, e.g., chloride. Accordingly, a preferred class of transition metal catalyst is the copper halides, e.g., Cu(I)Cl. It is also preferred that the transition metal catalyst contain a small amount, e.g., 1 mole percent, of a redox conjugate, for example, Cu(II)Cl₂, when Cu(I)Cl is used. Additional catalysts useful in preparing the pigment dispersant are described in U.S. Pat. No. 5,807,937 at column 18, lines 29 through 56. Redox conjugates are described in further detail in U.S. Pat. No. 5,807,937 at column 11, line 1 through column 13, line 38.

Ligands that may be used in ATRP for preparation of the polymerization catalyst include, but are not limited to, compounds having one or more nitrogen, oxygen, phosphorus and/or sulfur atoms, which can coordinate to the transition metal catalyst compound, e.g., through sigma and/or pi bonds. Classes of useful ligands include, but are not limited to, tertiary aliphatic amines, unsubstituted and substituted pyridines and bipyridines; porphyrins; cryptands; crown ethers; e.g., 18-crown-6; polyamines, e.g., ethylenediamine; glycols, e.g., alkylene glycols, such as ethylene glycol; carbon monoxide; and coordinating monomers, e.g., styrene, acrylonitrile and hydroxyalkyl(meth)acrylates. As used herein and in the claims, the term “(meth)acrylate” and similar terms refer to acrylates, methacrylates and mixtures of acrylates and methacrylates. A preferred class of ligands are the substituted bipyridines, e.g., 4,4′-dialkyl-bipyridyls. Additional ligands that may be used in preparing pigment dispersant are described in U.S. Pat. No. 5,807,937 at column 18, line 57 through column 21, line 43.

Typically, the ionic-functional or zwitterionic-functional monomer (i) is present in the reaction mixture in amounts of 10 to 100, usually 50 to 100 percent by weight; the percentages by weight being based on total monomer weight.

The ionic-functional or zwitterionic-functional polymer (a) is typically present in the film-forming composition used to form the coating layer in an amount of at least 0.005 percent by weight, such as at least 0.01 percent by weight or at least 0.1 percent by weight, and at most 5 percent by weight, such as at most 4 percent by weight or at most 3 percent by weight, based on the total weight of the film-forming composition. When used, the organometallic compound (b) is typically present in the film-forming composition in an amount of at least 0.005 percent by weight, such as at least 0.01 percent by weight or at least 0.1 percent by weight, and at most 2.5 percent by weight, such as at most 2 percent by weight or at most 1.5 percent by weight, based on the total weight of the film-forming composition. The balance of the film-forming composition (usually 92.5 to 99.985 percent by weight, based on the total weight of the film-forming composition) typically comprises a solvent component (c). Examples include haloalcohols such as trifluoroethanol or mixtures of haloalcohols with water and/or C1-C4 alcohols (methanol, ethanol, isopropanol, isobutanol, and the like).

The solution of the radically polymerizable monomer composition can be applied to the initiator-coated substrate (i. e., the activated surface) by conventional means such as dipping, rolling, spraying, printing, stamping or wiping to ensure uniform coating of the substrate surface. The solution may be applied to the entire substrate surface or over a portion thereof, such as in a predetermined pattern using a mask. The formation of the ATRP film or coating can occur at temperatures in the range of −10 to 150° C. and at pressures of 1-100 atmospheres, usually at ambient temperature and pressure. By “ambient” conditions is meant without the application of heat or other energy; for example, when a curable composition undergoes a thermosetting reaction without baking in an oven, use of forced air, irradiation, or the like to prompt the reaction, the reaction is said to occur under ambient conditions. Usually, ambient temperature ranges from 60 to 90° F. (15.6 to 32.2° C.), such as a typical room temperature, 72° F. (22.2° C.). The time for conducting the ATRP can vary depending on the thickness of the film desired. After ATRP, the coated substrate is removed from any remaining solution by rinsing with a polar solvent and drying the coated substrate.

When the activated surface of the initiator-coated substrate is exposed to the solution of the radically polymerizable monomer composition and subjected to ATRP conditions, the monomers contained therein form covalent bonds with each other and with the initiator groups that are bonded to the surface of the substrate 22. The resulting polymer has a low polydispersity index because chain transfer reactions are minimized. Lower polydispersity indices enable the molecular weight of the polymer to be controlled and optimized for the particular application intended.

The process may further include subjecting the coated substrate to heat or UV radiation to effect curing of any reactive functional groups on the polymers of the polymeric coating layer. Such curing may further ensure a robust and durable polymeric coating layer.

The term “cure”, “cured” or similar terms, as used in connection with a cured or curable composition, e.g., a “cured composition” of some specific description, means that at least a portion of any polymerizable and/or crosslinkable components that form the curable composition is polymerized and/or crosslinked. Additionally, curing of a composition refers to subjecting said composition to curing conditions such as heating or exposure to actinic radiation, depending on the chemistry, leading to the reaction of any reactive functional groups in the composition. The term “at least partially cured” means subjecting the composition to curing conditions, wherein reaction of at least a portion of the reactive groups of the composition occurs. The composition can be subjected to curing conditions as necessary depending on the composition of the coating layers, such that a substantially complete cure is attained and wherein further curing results in no significant further improvement in physical properties, such as hardness.

The resultant coated components are hydrophilic, demonstrating lubricity, and the polymeric coating layers serve as easy clean coatings and antifouling coatings. Moreover, unlike conventional hydrophilic polymers, the hydrophilic polymer (a) surprisingly is substantially insoluble in water at ambient temperature.

The film-forming compositions disclosed above form coating layers that are useful in methods of reducing adhesion of various substances, both organic and inorganic, to a substrate. This is unusual because most film-forming compositions that are used for anti-fouling purposes are effective for reducing adhesion of either organic or inorganic substances to a substrate, but not both. In fact, certain compositions, most notably fluorocarbon compositions, may mitigate adhesion of organic foulants but increase the deposition of inorganic scale on surfaces. The present disclosure is thus drawn to a method of reducing adhesion of an inorganic substance to a substrate. Such inorganic substances include barium sulfate, an iron sulfide, strontium sulfate and calcium carbonate scale. The substrate may include any of those disclosed above. The method comprises applying to at least one surface of the substrate a coating layer comprising: (a) a hydrophilic polymer that is ionic or zwitterionic such as any of those described above; and (b) optionally an organometallic compound as described above, applied to the substrate via spraying, brushing, or dipping.

Additionally, the present disclosure is drawn to a method of reducing adhesion of an organic substance to a substrate. Such organic substances include, for example, tar, resins, aromatic hydrocarbons, alkanes, bitumen, paraffinic compounds and asphaltene-type compounds. The substrate may include any of those disclosed above. The method comprises applying to at least one surface of the substrate a coating layer comprising: (a) a hydrophilic polymer that is ionic or zwitterionic such as any of those described above; and (b) optionally an organometallic compound as described above, applied to the substrate via spraying, brushing, or dipping.

Whereas particular embodiments of this invention have been described above for purposes of illustration, it will be evident to those skilled in the art that numerous variations of the details of the present invention may be made without departing from the scope of the invention as defined in the appended claims.

What is claimed is:

1. A coated article comprising:
(1) a substrate; and
(2) a coating layer applied to at least one surface of the substrate, the coating layer comprising:
(a) a hydrophilic polymer that is ionic or zwitterionic; and
(b) optionally an organometallic compound; wherein the substrate is a component of at least one of: an oil-water emulsion separator, a steam generator, an oil preheater, a pump, a valve, a pipe, a meter, a water heater, a water injection line, a distillation column, completion equipment, a storage tank, a clarifier, a settling tank, an HVAC system, a cooling tower, a pasteurizer, a refrigeration system, a chiller, a condenser, an evaporative cooler, a boiler, a condensate recovery system, a steam trap, a deaerator, an economizer, a water treatment system, a membrane, a seawater intake pipe, a ballast tank, a scrubber, a ship hull, a plumbing system, a plumbing fixture, an appliance, a humidifier, a dehumidifier, a brine treatment system, and food processing equipment.

2. The coated article of claim 1, wherein the substrate comprises at least one of metal oxide, cast iron, steel alloy, copper, copper alloy, aluminum, polyvinyl chloride (PVC), CPVC, rubber, fluoropolymer (PTFE), PEEK, fiber-reinforced plastic (FRP), ABS plastic, PEX plastic, concrete, cement, fused quartz glass, soda lime silica glass, sodium borosilicate glass, lead oxide glass, aluminosilicate glass, ceramic, polyolefin, nickel, nickel alloy, titanium, titanium alloy, chromium, chromium alloy, nickel-chromium alloy, and silicone.

3. The coated article of claim 1, wherein the hydrophilic polymer (a) is zwitterionic functional and comprises a reaction product of a reaction mixture comprising at least one ethylenically unsaturated zwitterionic monomer.

4. The coated article of claim 3, wherein the at least one ethylenically unsaturated zwitterionic monomer has the structure: 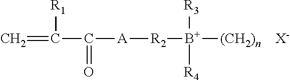
wherein R₁ is hydrogen or methyl; A is oxygen or —NH—; R₂ is ethylene, isopropylene or n-propylene; R₃ and R₄ are alkyl containing from 1 to 4 carbon atoms; B is N or P; n is an integer of 1 to 4; and X⁻ is SO₃⁻ or CO₂⁻.

5. The coated article of claim 4, wherein R₁ is hydrogen or methyl; A is —NH—; R₂ is n-propylene; R₃ and R₄ are methyl; B is N; n is 4; and X⁻ is SO₃⁻.

6. The coated article of claim 3, wherein the reaction mixture further comprises a different ethylenically unsaturated monomer comprising ethylene, propylene, styrene, vinyl toluene, (meth)acrylic acid, (meth)acrylamide, 3-(meth)acrylamidopropyl trialkylammonium chloride, N,N′-methylene di(meth)acrylamide, 2-(meth)acrylamido-2-methyl-1-propanesulfonic acid, 2-(meth)acrylamido-2-methyl-1-propylsodium sulfonate, 2-(meth)acrylamido-2,2-dimethylethylsodium sulfonate and/or an ester of (meth)acrylic acid.

7. The coated article of claim 1, wherein the hydrophilic polymer (a) is formed on the surface of the substrate by reaction of monomers on the surface of the substrate, the monomers comprising at least one ethylenically unsaturated zwitterionic monomer and at least one different ethylenically unsaturated monomer, and wherein the hydrophilic polymer (a) is substantially insoluble in water at ambient temperature.

8. The coated article of claim 1, wherein the organometallic compound (b) is present in the coating layer and comprises tantalum, titanium, zirconium, lanthanum, hafnium, niobium, aluminum and/or tungsten.

9. A coated component of an oil-water emulsion separator comprising:
(1) a substrate; and
(2) a coating layer applied to at least one surface of the substrate, the coating layer comprising:
(a) a hydrophilic polymer that is ionic or zwitterionic; and
(b) optionally an organometallic compound.

10. The coated component of claim 9, wherein the substrate comprises at least one of metal oxide, cast iron, steel alloy, copper, copper alloy, aluminum, polyvinyl chloride (PVC), CPVC, fiber-reinforced plastic (FRP), ABS plastic, PEX plastic, concrete, cement, polyolefin, nickel, nickel alloy, titanium, titanium alloy, chromium, chromium alloy, nickel-chromium alloy, and silicone.

11. The coated component of claim 9, wherein the hydrophilic polymer (a) is zwitterionic functional and comprises a reaction product of a reaction mixture comprising at least one ethylenically unsaturated zwitterionic monomer.

12. The coated component of claim 11, wherein the at least one ethylenically unsaturated zwitterionic monomer has the structure: 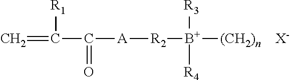
wherein R₁ is hydrogen or methyl; A is oxygen or —NH—; R₂ is ethylene, isopropylene or n-propylene; R₃ and R₄ are alkyl containing from 1 to 4 carbon atoms; B is N or P; n is an integer of 1 to 4; and X⁻ is SO₃⁻ or CO₂⁻.

13. A method of reducing adhesion of an organic substance and/or an inorganic substance to a substrate, comprising applying to at least one surface of the substrate a coating layer comprising:
(a) a hydrophilic polymer that is ionic or zwitterionic; and
(b) optionally an organometallic compound; wherein the substrate is a component of at least one of: an oil-water emulsion separator, a steam generator, an oil preheater, a pump, a valve, a pipe, a meter, a water heater, a water injection line, a distillation column, completion equipment, a storage tank, a clarifier, a settling tank, an HVAC system, a cooling tower, a pasteurizer, a refrigeration system, a chiller, a condenser, an evaporative cooler, a boiler, a condensate recovery system, a steam trap, a deaerator, an economizer, a water treatment system, a membrane, a seawater intake pipe, a ballast tank, a scrubber, a ship hull, a plumbing system, a plumbing fixture, an appliance, a humidifier, a dehumidifier, a brine treatment system, and food processing equipment.

14. The method of claim 13, wherein the substance comprises an inorganic substance, the inorganic substance comprising at least one of barium sulfate, an iron sulfide, strontium sulfate and calcium carbonate scale.

15. The method of claim 13, wherein the substance comprises an organic substance, the organic substance comprising at least one of tar, resin, aromatic hydrocarbon, an alkane, bitumen, a paraffinic compound and asphaltene-type compounds.

16. The method of claim 13, wherein the substrate comprises at least one of metal oxide, cast iron, steel alloy, copper, copper alloy, aluminum, polyvinyl chloride (PVC), CPVC, rubber, fluoropolymer (PTFE), PEEK, fiber-reinforced plastic (FRP), ABS plastic, PEX plastic, concrete, cement, fused quartz glass, soda lime silica glass, sodium borosilicate glass, lead oxide glass, aluminosilicate glass, ceramic, polyolefin, nickel, nickel alloy, titanium, titanium alloy, chromium, chromium alloy, nickel-chromium alloy, and silicone.

17. The method of claim 13, wherein the hydrophilic polymer (a) is zwitterionic functional and comprises a reaction product of a reaction mixture comprising at least one ethylenically unsaturated zwitterionic monomer.

18. The method of claim 17, wherein the at least one ethylenically unsaturated zwitterionic monomer has the structure: 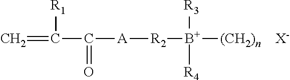
wherein R₁ is hydrogen or methyl; A is oxygen or —NH—; R₂ is ethylene, isopropylene or n-propylene; R₃ and R₄ are alkyl containing from 1 to 4 carbon atoms; B is N or P; n is an integer of 1 to 4; and X⁻ is SO₃⁻ or CO₂⁻.

19. The method of claim 18, wherein R₁ is hydrogen or methyl; A is —NH—; R₂ is n-propylene; R₃ and R₄ are methyl; B is N; n is 4; and X⁻ is SO₃⁻.

20. The method of claim 17, wherein the reaction mixture further comprises a different ethylenically unsaturated monomer comprising ethylene, propylene, styrene, vinyl toluene, (meth)acrylic acid, (meth)acrylamide, 3-(meth)acrylamidopropyl trialkylammonium chloride, N,N′-methylenedi(meth)acrylamide, 2-(meth)acrylamido-2-methyl-1-propanesulfonic acid, 2-(meth)acrylamido-2-methyl-1-propylsodium sulfonate, 2-(meth)acrylamido-2,2-dimethylethylsodium sulfonate and/or an ester of (meth)acrylic acid.
